(19) United States
(12) Patent Application Publication
(10) Pub. No.: US 2019/0379468 A1
(43) Pub. Date: Dec. 12, 2019

(54) TECHNIQUES FOR CHANNEL STATE DETERMINATION

(71) Applicant: INTEL IP CORPORATION, Santa Clara, CA (US)

(72) Inventors: Sabine ROESSEL, Munich (DE); Stefania SESIA, Roquefort les Pins (FR); Tommaso BALERCIA, San Francisco, CA (US); Christian DREWES, Germering (DE); Josef HAUSNER, Germering (DE); Patricia GUITTON-OUHAMOU, Mouans-Sartoux (FR)

(73) Assignee: INTEL IP CORPORATION, Santa Clara, CA (US)

(21) Appl. No.: 16/488,354

(22) PCT Filed: Mar. 31, 2017
(86) PCT No.: PCT/US17/25629

§ 371 Date: Aug. 23, 2019

(51) Int. Cl. H04B 17/309; H04L 25/02; H04W 24/10

(52) U.S. Cl. CPC H04B 17/309; H04W 24/10; H04L 25/0204

(57) ABSTRACT

Various embodiments are generally directed to techniques for channel state determination, such as, for instance, determining one or more channel state parameters for a wireless communication channel between a user equipment (UE) and a base station in a mobile network. Some embodiments are particularly directed to a radio access network (RAN) control system that determines one or more channel state parameters for wireless communication channels in a RAN portion of a mobile network based on propagation data in a channel state base (CSB) database. For example, propagation behavior of a wireless communication channel between a UE and a base station may be calculated by the radio access KSPCS based, at least in part, on propagation data in the CSB database and a physical location of the UE.

### BACKGROUND

A mobile network may refer to a communication network where the last link is wireless. Often the last link in a mobile network may be a wireless communication channel between a mobile device and a base station, such as a wireless communication channel in a radio access network (RAN). Typically, a mobile network may be distributed over land areas called cells. Each cell may be served by at least one base station. The base station may provide user equipment (UE) within the cell with network coverage that can be used for the transmission of data. In many mobile networks, channel estimation and equalization may be used to prevent distortion incurred by a signal transmitted via a wireless communication channel, such as between a mobile device and a base station.

### BRIEF DESCRIPTION OF THE DRAWINGS

FIG. 1 illustrates an embodiment of a first operating environment.

FIG. 2 illustrates an embodiment of a second operating environment.

FIG. 3 illustrates an embodiment of a third operating environment.

FIG. 4 illustrates an embodiment of a fourth operating environment.

FIG. 5 illustrates an embodiment of a first logic flow.

FIG. 6 illustrates an embodiment of a second logic flow.

FIG. 7 illustrates an embodiment of a storage medium.

FIG. 8 illustrates an embodiment of a computing architecture.

FIG. 9 illustrates an embodiment of a communications architecture.

FIG. 10 illustrates an embodiment of a device.

FIG. 11 illustrates an embodiment of a wireless network.

### DETAILED DESCRIPTION

Various embodiments are generally directed to techniques for channel state determination, such as, for instance, determining one or more channel state parameters for a wireless communication channel between a user equipment (UE) and a base station in a mobile network. Some embodiments are particularly directed to a radio access knowledge server and parameter control system (KSPCS) that determines one or more channel state parameters for wireless communication channels in a radio access network (RAN) portion of a mobile network based on propagation data in a channel state base (CSB) database. For example, propagation behavior of a wireless communication channel between a UE and a base station may be calculated by the radio access KSPCS based, at least in part, on propagation data in the CSB database and a physical location of the UE. In some such examples, the propagation behavior may be used to determine one or more channel state parameters for the wireless communication channel between the UE and the base station. In various embodiments, propagation data may indicate propagation characteristics for a plurality of physical locations in a RAN. In some embodiments, the radio access KSPCS may utilize channel agents to perform measurements associated with propagation of wireless signals in the RAN. In some such embodiments, the radio access KSPCS may generate and/or modify propagation data based on the measurements associated with propagation of wireless signals in the RAN. These and other embodiments are described and claimed.

Some challenges facing channel state determination in mobile networks include the use of excessively complex, bulky, and inefficient techniques to determine channel state parameters. These challenges may result from mobile networks requiring UE, such as mobile devices, to perform one or more portions of channel estimation (e.g., channel state information (CSI) feedback) to enable determination of channel state parameters. Channel estimation can be a complex task that provides one of the main bottlenecks to energy efficient and die area efficient implementations. For instance, channel estimation can be particularly demanding in the presence of complex interferer profiles. In another example, advanced interference mitigation can require that interferer channels be estimated in addition to the serving channel. Additionally, the amount of channel estimations that will have to be performed in the future will increase in order to detect several potential interference or beamforming options, further increasing the burden associated with channel estimation. For example, with an increase in the number of transceivers and antennas (translating into a larger number of multiple-in and multiple-out (MIMO) layers and different beamforming alternatives), the signaling overhead for providing feedback from the UE to the network increases and can outweigh spectral efficiency gains.

Adding further complexity, components of a mobile network can be very sensitive to channel estimation errors and channel estimation may drop in accuracy with future generation mobile networks (e.g., 5G, 6G, etc.). In future generation mobile networks, pilot tones and symbols used for channel estimation may be less static in frequency, time, and spatial grid, as well as reduced in number. For instance, cell-specific reference symbols (CRS) may be substituted for dynamically configured channel state information reference symbols (CSI-RS) and UE-specific demodulation reference symbols (DMRS). Due to the sparseness and dynamicity of pilot tones and symbols, without resorting to highly complex alternatives, the accuracy of standard channel estimation techniques may drop. As a consequence, throughput and call performance of the mobile network may be negatively impacted. These and other factors may result in mobile networks with poor performance and limited efficiency. Such limitations can drastically reduce the capabilities, usability, and applicability of the mobile networks, contributing to ineffective systems with limited capabilities.

Various embodiments described herein include a radio access KSPCS that continuously and in real-time optimizes and controls channel state towards one or more devices within a radio access network (RAN). In some embodiments, the radio access KSPCS may accurately determine channel state parameters for a wireless communication channel between a UE and a base station in an open loop manner (e.g., without requiring a UE to perform aspects of channel estimation). In various embodiments, the radio access KSPCS may efficiently determine channel state parameters based on propagation data stored in a CSB database that indicates propagation characteristics associated with a plurality of physical locations in the RAN. In various such embodiments, the radio access KSPCS may generate and/or modify the propagation data based on measurements associated with propagation of a wireless signal in the RAN. For example, a radio access KSPCS may generate a propagation map that indicates propagation characteristics for a variety of physical locations in a RAN based on measurements performed by one or more channel agents regarding propagation of wireless signals in the RAN. In some embodiments, the radio access KSPCS may utilize the propagation data to pre-process data for transmission via a wireless communication channel without the need for a UE to perform aspects of channel estimation, such as CSI feedback. In some such embodiments, this may considerably reduce the amount of uplink traffic generated to determine channel state parameters. In these and other ways the radio access KSPCS may enable quick and reliable determination of channel state parameters in an open loop manner to achieve improved mobile network performance with increased throughput and higher efficiencies, resulting in several technical effects and advantages.

In one embodiment, for example, an apparatus for channel state determination may comprise a memory and logic, at least a portion of the logic implemented in circuitry coupled to the memory. The logic may identify a physical location of a user equipment (UE) in a radio access network (RAN) that includes a base station, identify propagation data in a channel state base (CSB) database based on the physical location of the UE, and determine a channel state parameter for a wireless communication channel between the UE and the base station based on the propagation data and the physical location of the UE.

In another embodiment, for example, a system for channel state determination may include a radio access network (RAN) comprising a channel agent, and a channel server. The channel agent may perform a measurement associated with propagation of a wireless signal in the RAN and produce base data based on the measurement. The channel server may identify the base data in a communication, determine a physical location in the RAN associated with the base data, and generate propagation data to store in a channel state base (CSB) database based on the physical location and the base data.

With general reference to notations and nomenclature used herein, one or more portions of the detailed description which follows may be presented in terms of program procedures executed on a computer or network of computers. These procedural descriptions and representations are used by those skilled in the art to most effectively convey the substances of their work to others skilled in the art. A procedure is here, and generally, conceived to be a self-consistent sequence of operations leading to a desired result. These operations are those requiring physical manipulations of physical quantities. Usually, though not necessarily, these quantities take the form of electrical, magnetic, or optical signals capable of being stored, transferred, combined, compared, and otherwise manipulated. It proves convenient at times, principally for reasons of common usage, to refer to these signals as bits, values, elements, symbols, characters, terms, numbers, or the like. It should be noted, however, that all of these and similar terms are to be associated with the appropriate physical quantities and are merely convenient labels applied to those quantities.

Further, these manipulations are often referred to in terms, such as adding or comparing, which are commonly associated with mental operations performed by a human operator. However, no such capability of a human operator is necessary, or desirable in most cases, in any of the operations described herein that form part of one or more embodiments. Rather, these operations are machine operations. Useful machines for performing operations of various embodiments include general purpose digital computers as selectively activated or configured by a computer program stored within that is written in accordance with the teachings herein, and/or include apparatus specially constructed for the required purpose. Various embodiments also relate to apparatus or systems for performing these operations. These apparatuses may be specially constructed for the required purpose or may include a general-purpose computer. The required structure for a variety of these machines will be apparent from the description given.

Various embodiments may comprise one or more elements. An element may comprise any structure arranged to perform certain operations. Each element may be implemented as hardware, software, or any combination thereof, as desired for a given set of design parameters or performance constraints. Although an embodiment may be described with a limited number of elements in a certain topology by way of example, the embodiment may include more or less elements in alternate topologies as desired for a given implementation. It is worthy to note that any reference to “one embodiment” or “an embodiment” means that a particular feature, structure, or characteristic described in connection with the embodiment is included in at least one embodiment. The appearances of the phrases “in one embodiment,” “in some embodiments,” and “in various embodiments” in various places in the specification are not necessarily all referring to the same embodiment.

The techniques disclosed herein may involve transmission of data over one or more wireless connections using one or more wireless mobile broadband technologies. For example, various embodiments may involve transmissions over one or more wireless connections according to one or more 3rd Generation Partnership Project (3GPP), 3GPP New Radio (3GPP 5G), 6^{th} Generation Evolution of the 3GPP standard (3GPP 6G), 3GPP Long Term Evolution (LTE), and/or 3GPP LTE-Advanced (LTE-A) technologies and/or standards, including their revisions, progeny and variants. Various embodiments may additionally or alternatively involve transmissions according to one or more Global System for Mobile Communications (GSM)/Enhanced Data Rates for GSM Evolution (EDGE), Universal Mobile Telecommunications System (UMTS)/High Speed Packet Access (HSPA), and/or GSM with General Packet Radio Service (GPRS) system (GSM/GPRS) technologies and/or standards, including their revisions, progeny and variants.

Examples of wireless mobile broadband technologies and/or standards may also include, without limitation, any of the Institute of Electrical and Electronics Engineers (IEEE) 802.16 wireless broadband standards such as IEEE 802.16m and/or 802.16p, International Mobile Telecommunications Advanced (IMT-ADV), Worldwide Interoperability for Microwave Access (WiMAX) and/or WiMAX II, Code Division Multiple Access (CDMA) 2000 (e.g., CDMA2000 1xRTT, CDMA2000 EV-DO, CDMA EV-DV, and so forth), High Performance Radio Metropolitan Area Network (HIPERMAN), Wireless Broadband (WiBro), High Speed Downlink Packet Access (HSDPA), High Speed Orthogonal Frequency-Division Multiplexing (OFDM) Packet Access (HSOPA), High-Speed Uplink Packet Access (HSUPA) technologies and/or standards, including their revisions, progeny and variants.

Some embodiments may additionally or alternatively involve wireless communications according to other wireless communications technologies and/or standards. Examples of other wireless communications technologies and/or standards that may be used in various embodiments may include, without limitation, other IEEE wireless communication standards such as the IEEE 802.11, IEEE 802.11a, IEEE 802.11b, IEEE 802.11g, IEEE 802.11n, IEEE 802.11u, IEEE 802.11ac, IEEE 802.11ad, IEEE 802.11af, and/or IEEE 802.11ah standards, High-Efficiency Wi-Fi standards developed by the IEEE 802.11 High Efficiency WLAN (HEW) Study Group, Wi-Fi Alliance (WFA) wireless communication standards such as Wi-Fi, Wi-Fi Direct, Wi-Fi Direct Services, Wireless Gigabit (WiGig), WiGig Display Extension (WDE), WiGig Bus Extension (WBE), WiGig Serial Extension (WSE) standards and/or standards developed by the WFA Neighbor Awareness Networking (NAN) Task Group, machine-type communications (MTC) standards such as those embodied in 3GPP Technical Report (TR) 23.887, 3GPP Technical Specification (TS) 22.368, and/or 3GPP TS 23.682, and/or near-field communication (NFC) standards such as standards developed by the NFC Forum, including any revisions, progeny, and/or variants of any of the above. The embodiments are not limited to these examples.

In addition to transmission over one or more wireless connections, the techniques disclosed herein may involve transmission of content over one or more wired connections through one or more wired communications media. Examples of wired communications media may include a wire, cable, metal leads, printed circuit board (PCB), backplane, switch fabric, semiconductor material, twisted-pair wire, co-axial cable, fiber optics, and so forth. The embodiments are not limited in this context.

Reference is now made to the drawings, wherein like reference numerals are used to refer to like elements throughout. In the following description, for purpose of explanation, numerous specific details are set forth in order to provide a thorough understanding thereof. It may be evident, however, that the novel embodiments can be practiced without these specific details. In other instances, well known structures and devices are shown in block diagram form in order to facilitate a description thereof. The intention is to cover all modification, equivalents, and alternatives within the scope of the claims

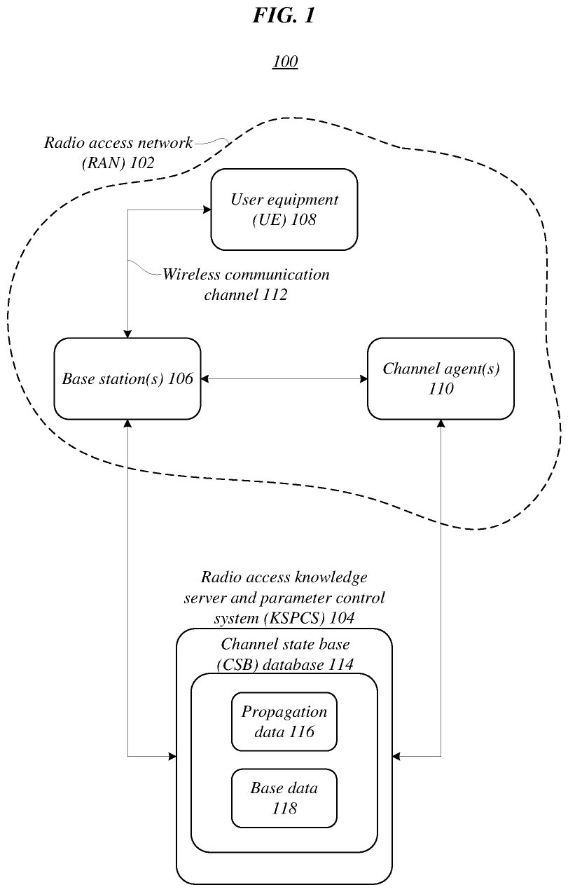

FIG. 1 illustrates an example of an operating environment 100 that may be representative of various embodiments. Operating environment 100 may include a radio access network (RAN) 102 and a radio access KSPCS 104. In the illustrated embodiment, RAN 102 may include base station 106, user equipment (UE) 108, channel agent 110, and wireless communication channel 112 and radio access KSPCS 104 may include channel state base (CSB) database 114 with propagation data 116 and base data 118. In operating environment 100, radio access KSPCS 104 may determine one or more channel state parameters for wireless communication channel 112 based on propagation data 116 and/or base data 118 in CSB database 114. For example, radio access KSPCS 104 may identify a physical location of UE 108 in RAN 102, identify a portion of propagation data 116 in CSB database 114 based on the physical location of UE 108, and determine a channel state parameter for wireless communication channel 112 based on the portion of propagation data 116 and the physical location of the UE. In various embodiment described herein, the determination of channel state parameters for wireless communication channel 112 by radio access KSPCS 104 may improve the performance and efficiency of RAN 102 by limiting the participation of UE 108 in determining channel state parameters (e.g., UE 108 performing channel estimation). Embodiments are not limited in this context.

In various embodiments, radio access KSPCS 104 may utilize one or more channel agents 110 to generate propagation data 116. In various such embodiments, radio access KSPCS 104 may direct channel agents 110 to perform one or more measurements of propagating signals and/or conditions affecting propagating signals. In some embodiments, data associated with the one or more measurements may be stored in CSB database 114 as base data 118. In some such embodiments, radio access KSPCS 104 may use base data 118 to generate propagation data 116.

In one or more embodiments, propagation data 116 may refer to information related to a radio propagation topology of RAN 102. In such embodiments, radio access KSPCS 104 may utilize propagation data 116 to determine or estimate a propagation behavior of wireless communication channel 112 between UE 108 and one or more base stations 106. In various embodiments, propagation data 116 may include a propagation map that indicates propagation characteristics for a plurality of physical locations within RAN 102. In some embodiments, selection of one or more channel state parameters may be made based on the propagation behavior of wireless communication channel 112 as determined or estimated from propagation data 116. In various embodiments, a channel state parameter may refer to one or more wireless communication channel properties or settings of a communication link that affect how a signal propagates, is transmitted, and/or is received in RAN 102.

In various embodiments, RAN 102 may form a portion of a mobile network that communicatively couples various devices to the core of the mobile network via a wireless link or air interface. In various such embodiments, RAN 102 may connect UE 108 to the core of a cellular network via base station 106. For instance, UE 108 may include a mobile phone and base station 106 may include a cell tower. In some embodiments, RAN 102 may utilize one or more radio access technologies (RATs) to communicatively couple various devices, such as Wi-Fi, Bluetooth™, 3G, 4G, LTE, 5G, 6G, or any other wireless communication technologies.

In some embodiments, channel agents 110 may include dedicated hardware, such as one or more sensors, transmitters, receivers, radio elements connected to a structure of in-building antenna(s), antenna elements of a wall-mounted antenna array, remote radio heads (RRHs), or devices of an underlay device-to-device (D2D) network. In various embodiments, channel agents that include dedicated hardware may be referred to as ‘dedicated’ channel agents. In some embodiments, channel agents that do not include dedicated hardware may be referred to as ‘temporary’ channel agents, and as described further below, one or more UE 108 may act as temporary channel agents.

In various embodiments, radio access KSPCS 104 may determine one or more channel state parameters for wireless communication channel 112 in a purely open loop manner In other words, radio access KSPCS 104 may not require or use any feedback from UE 108 to determine one or more channel state parameters for a transmission from UE 108 to base station 106 via wireless communication channel 112. However, in other embodiments, radio access KSPCS 104 may cause or request UE 108 to act as a temporary channel agent, such as for a given amount of time, frequency, and/or antenna ports. For instance, UE 108 may be used in a RAN 102 of a new campus or building with no or an incomplete CSB database 114 and radio access KSPCS 104 may utilize a portion throughput and air-time for UE 108 to provide base data 118. In various embodiments, an amount of channel agent activities may be performed by UE 108 pursuant a subscriber contract. In some embodiments, radio access KSPCS 104 may request UE 108 to serve as a channel agent. In some such embodiments, acting as channel agent may be on a case-by-case basis as accepted by a subscriber.

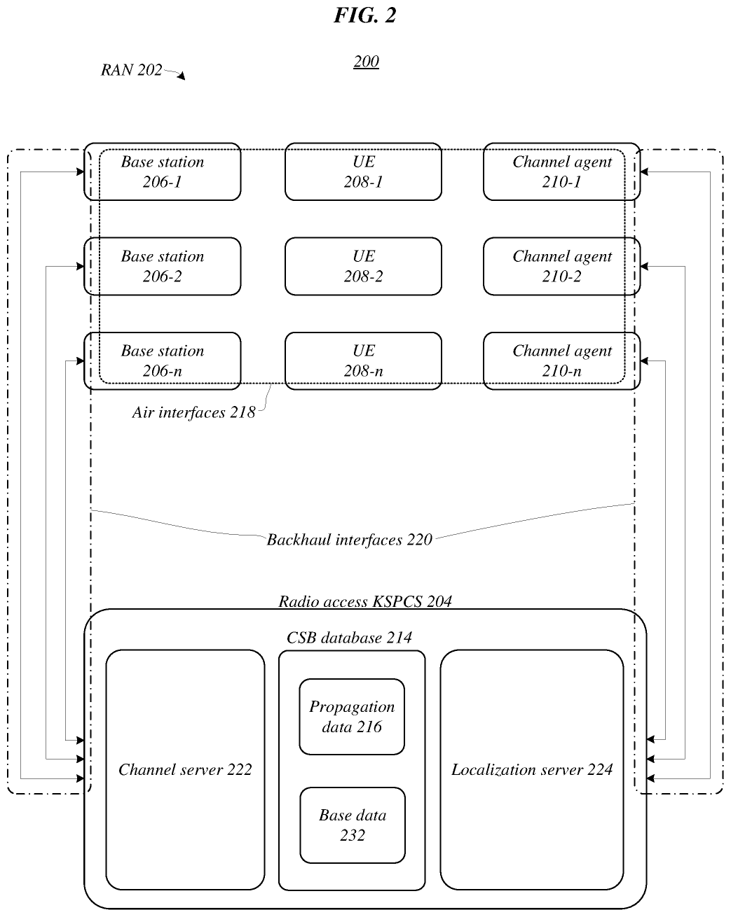

FIG. 2 illustrates an embodiment of an operating environment 200 that may be representative of operations one or more of base stations 206-1, 206-2, 206-n (i.e. base stations 206), UEs 208-1, 208-2, 208-n (i.e., UEs 208), channel agents 210-1, 210-2, 210-n (i.e., channel agents 210), and radio access KSPCS 204 may perform in various embodiments to enable radio access KSPCS 204 to know and control in real-time the wireless channel that a UE experiences via air interfaces 218. In various embodiments, one or more of base stations 206-1, 206-2, 206-n, UEs 208-1, 208-2, 208-n, channel agents 210-1, 210-2, 210-n, or radio access KSPCS 204 may be the same or similar to one or more of base station(s) 106, UE 108, channel agent(s) 110, or radio access KSPCS 104. In operating environment 200, radio access KSPCS 204 may include channel server 222, CSB database 214, and localization server 224. In various embodiments described herein, components of operating environment 200 may interoperate to create an expected level of or maximizing the signal-to-interference-plus-noise ratio (SINR) as well as the number of streams for one or more wireless communication channels. Embodiments are not limited in this context.

In the illustrated embodiment, radio access KSPCS 204 may include channel server 222, CSB database 214, and localization server 224. In various embodiments, channel server 222 may dynamically optimize and control the channel state towards devices communicatively coupled to RAN 202, such as via one or more of base stations 206-1, 206-2, 206-n. In various such embodiments, channel server 222 may dynamically optimize and control channel states by applying machine-learning techniques to base data 232 to predict or estimate propagation topology of RAN 202 and store it as propagation data 216 in CSB database 214. In some embodiments, base data 232 may be generated based on measurements (e.g., by channel agent 210-1, 210-2, or 210-n) and/or ray-tracing calculations for identifying, interpolating, and/or extrapolating base data 232 in CSB database 214. In some embodiments, localization server 224 may monitor a physical location of devices communicatively coupled to RAN 202 (e.g., UE 208-1, 208-2, 208-n). In some such embodiments, an indication of physical location of a UE and determined by localization server 224 may be shared with channel server 222 to enable channel server 222 to continually optimize and control the channel towards that UE. For instance, channel server 222 may identify a location of UE 208-1 from localization server 224 and determine one or more channel state parameters for a communication from base station 206-2 to UE 208-1 based on the location of UE 208-1 and a portion of propagation data 216 associated with the location of UE 208-1.

Operating environment 200 may include air interfaces 218 and backhaul interface 220. In various embodiments, air interfaces 218 may refer to the collection of wireless communication channels between communicatively coupled devices within RAN 202 (e.g., base station 206-1 and UE 208-n). For instance, input to and channel state provisioning from radio access KSPCS 204 may occur between UEs 208 or channel agents 210 and one or more of base stations 206 via air interfaces 218. In one or more embodiments described herein, devices that are communicatively coupled to radio access KSPCS 204 via one or more air interfaces 218 and/or backhaul interfaces 220 of RAN 202 may be referred to as being “in”, “of”, “connected to”, or “within” RAN 202. In some embodiments, backhaul interface 220 may refer to the collection of communication links that connects RAN 202 to a core network that includes radio access KSPCS 204. For example, input to and channel state provisioning from radio access KSPCS may occur between base stations 206 or channel agents 210 and radio access KSPCS 204 via backhaul interfaces 220. In some embodiments, backhaul interfaces 220 may be wired interfaces.

In various embodiments, UEs 208 may have one or more roles within RAN 202, such as a temporary channel agent or a regular consumer device. For instance, if a UE is used in a new campus or building with no or an incomplete CSB database, the RAN and the UE may interact normally, but on a significantly lower service level while major parts of the UE's throughput and air-time will be used to provide base data. In some embodiments, one or more portions of propagation data 216 may be generated based on the base data and an accurate location, position, or orientation of the UE or antennas. In some such embodiments, propagation data 216 may also be generated based on other device-specific geometric and position associated information. For example, device-specific geometric and position associated information may include an interpolation of position information provided by a UE, such as part of a minimization drive test (MDT), as well as additional information obtained by one or more of channel agents 210. In various embodiments, one or more of channel agents 210 may provide static geometric base data of RAN 202.

In some embodiments, the default roles of UEs 208 within RAN 202 may be as a consumer device. In some such embodiments, acting as a temporary channel agent may be on a case-by-case basis, as accepted by the subscriber. In various embodiments, some minimum amount of channel agent activity may be factored into a subscriber's contract. In some embodiments, when a device is acting as a regular consumer device, it may not be required to provide feedback information or limit its feedback to essential information such as, acknowledgement/negative-acknowledgement (ACK/NAK) signals or measurements aimed at reporting its position, for example.

In various embodiments, base stations 206 may have one or more roles within RAN 202. In some embodiments, one role may include interacting with dedicated channel agents (e.g., channel agents 210) and temporary channel agents (e.g., UEs 208) to create or update one or more portions of CSB database (e.g., propagation data 216 or base data 232). For example, the interactions may include one or more of transmit (TX) and receive (RX) antenna steering, beamforming of transmitting and receiving channel agents, UE detection, actors and sensors to measure in-building propagation conditions, actors and sensors to measure obstacles, actors and sensors to measure UE mobility, geometric, and position data, sensors to detect climate effects on propagation, and the like.

In some embodiments, one role may include interacting with UEs in their consumer device role. In various embodiments, channel server 222 may combine current UE-related geometrical and positional information retrieved from localization server 224 with static channel/topology knowledge and an estimated or predicted actual channel situation in order to determine one or more channel state parameters of a wireless communication channel utilized by a UE in a consumer device role. In various such embodiments, static channel/topology knowledge may include one or more of multi-path propagation conditions, noise or interference level, precoding and beamforming options of the network, uplink received channel conditions, and the like. In some embodiments, the estimated or predicted actual channel situation may include one or more of physical obstacles, room temperature or humidity, weather forecast, or the like.

In some embodiments, channel state parameters may include antenna element(s) and/or RRH selection for reception in a dynamic reception point/antenna port selection, antenna element(s) and/or RRH selection for transmission (not necessarily the same as for reception) in a dynamic transmission point/antenna port selection. In various embodiments, channel state parameters may include antenna array control for reception or antenna array control for transmission. In some embodiments, channel state parameters may include settings for actuators to control reflections and/or absorption of walls. In various embodiments, channel state parameters may include selection of other devices for transmission or reception support based on network coding.

In various embodiments, determining one or more channel state parameters may enable or include creation of a channel with a given rank and/or a given propagation behavior such that the network can autonomously decide on precoding, modulation and coding scheme (MCS), and frequency/time/spatial allocation (i.e., prefiltering for a transmission between a base station and a UE). In some embodiments, channel control by channel server 222 may completely avoid the need of hybrid automatic repeat request (HARQ) and the related PHY-level ACK/NACK interaction between UE and RAN. In various embodiments, if the channel server is not sufficiently accurate, the lack of accuracy may be recognized from higher level HARQ activity. In various such embodiments, the channel server may issue a request to the localization server for a higher quality estimate of the location of the UE.

In some embodiments, channel server 222 may perform/include one or more of the following functions, algorithms, methods, and/or features. In various embodiments, channel server 222 may send training information to a UE (e.g., a beamforming transmission scheme). In one or more embodiments, channel server 222 may receive training information from a UE (e.g., a device location or orientation). In some embodiments, channel server 222 may configure one or more channel agents 210 to sense information related to the environment topology, such as during a specified period of time. In some such embodiments, channel server 222 may receive the information from the one or more channel agents 210 in the form of feedback or update of the feedback.

In various embodiments, channel server 222 may match UE location information from localization server 224 with channel characteristics in order to create a quality of service-transmission characteristics-position grid. In various such embodiments, the quality of service-transmission characteristics-position grid may include a propagation map stored in propagation data 216. In some embodiments, channel server 222 may post-process information received from one or more channel agents in order to create a topology of the environment of RAN 202. In some such embodiments, post-processing may involve machine-learning techniques in order to increase the predictive part of the channel server 222, or the realization of coarse maps used with methods to predict propagation, such as ray-tracing.

In some embodiments, channel server 222 may autonomously adjust one or more channel state parameters for transmission in order to optimize end user experience. In some such embodiments, channel server 222 may utilize machine-learning techniques to autonomously adjust the one or more channel state parameters. In various embodiments, channel server 222 may autonomously adjust one or more channel state parameters for transmission pre-filtering in order to optimize end user experience. In some embodiments, channel server 222 may send indications of channel state parameters to an intended UE in an open-loop manner In various embodiments, channel server 222 may create a low rate channel such that a UE can request for an uplink grant. In various such embodiments, a low rate channel may have a capacity of ten or fewer megabytes per second. In some embodiments, channel server 222 may create a wireless communication channel for optimal reception for a UE.

In various embodiments, one or more of UEs 208 may perform/include one or more of the following functions, algorithms, methods, and/or features. In some embodiments, a UE may allow an application to use positioning information for the purpose of quality of service topology. In various embodiments, a UE may send information about the quality of service and positioning information respectively to channel server 222 and localization server 224. In some embodiments, a UE may accept to serve as a temporary channel agent. In some such embodiments, a UE may receive signaling from a base station requesting the UE act for a certain period of time, for certain resources, and/or certain antenna ports as the temporary channel agent.

In various embodiments, a UE may receive data with limited (e.g., only ACK/NACK, rare channel state information, or any combination described herein) or no feedback. In some embodiments, a UE may transmit data with limited (e.g., only ACK/NACK, rare channel state information, or any combination described herein) or no feedback.

In some embodiments, one or more of channel agents 210 may perform/include one or more of the following function, algorithms, methods, and/or features. In various embodiments, a channel agent may be capable of receiving limited semi-static configuration information from a RAN. For example, in the case of a sensor, to adjust its sensing characteristics, such as the parameter it senses, the periodicity of the sensing, and the time interval during which to sense. In some embodiments, a channel agent may sense the environment and transmit the information to the network (e.g., as base data 232). In various embodiments, a channel agent (e.g., a transmitter) may probe the environment (e.g., with a training radio beam). In various such embodiments, the channel agent may collaborate with other channel agents (e.g., a sensor) via channel server 222.

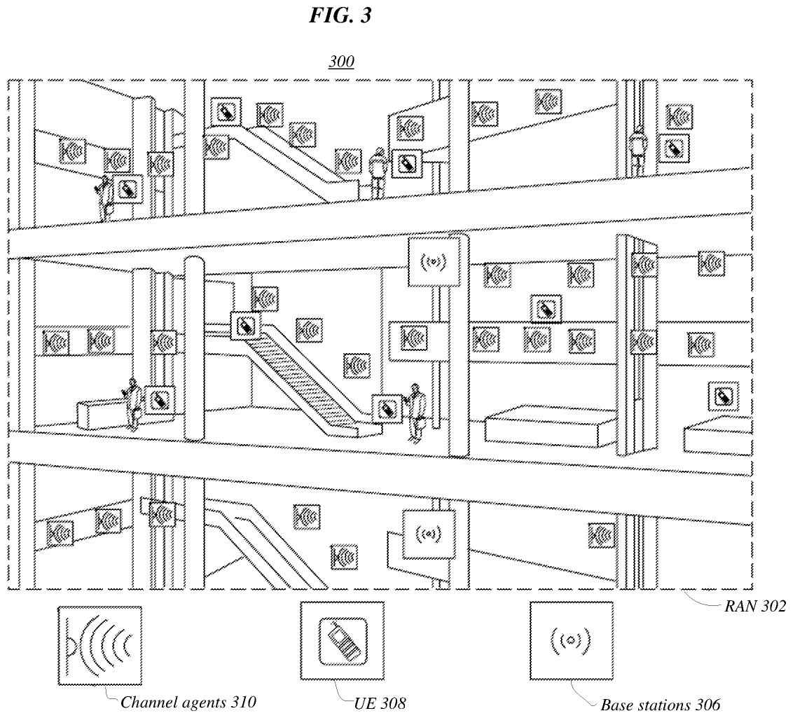

FIG. 3 illustrates an example of an operating environment 300 that may be representative of various embodiments. Operating environment 300 may illustrate a RAN 302 deployed within an office building. In various embodiments, RAN 302 may be the same or similar to RAN 102 and/or RAN 202. As can be seen in FIG. 3, operating environment 300 includes channel agents 310, UE 308, and base stations 306 within RAN 302. In operating environment 300, a radio access KSPCS (not shown) may determine one or more channel state parameters for wireless communication channels between the different devices (e.g., one or more base stations 306 and one or more UEs 308). In various embodiment described herein, the determination of channel state parameters for wireless communication between different devices may improve the performance and efficiency of RAN 302 within an office building by limiting the participation of UE 108 in determining channel state parameters (e.g., UE 108 performing channel estimation). Embodiments are not limited in this context.

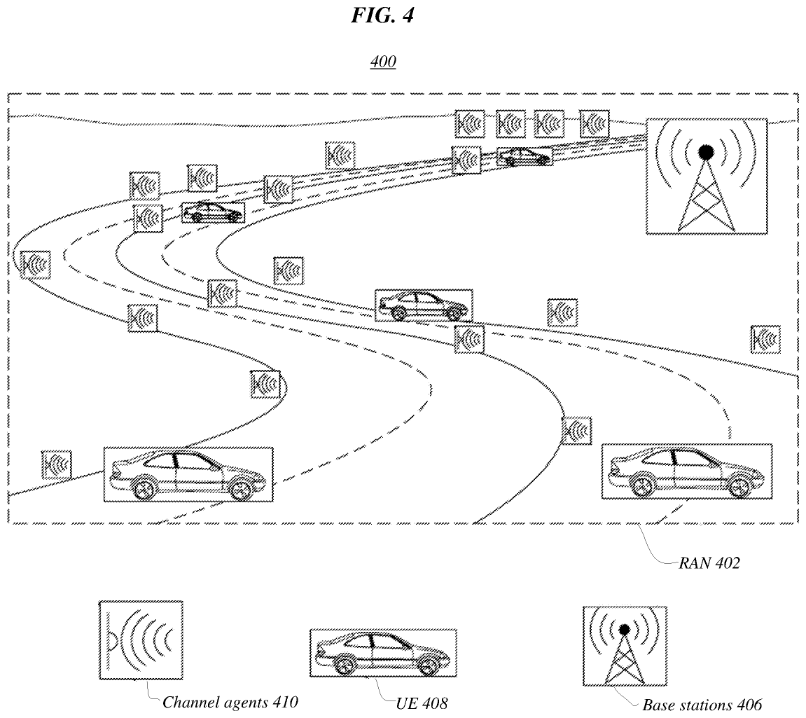

FIG. 4 illustrates an example of an operating environment 400 that may be representative of various embodiments. Operating environment 400 may illustrate a RAN 402 deployed along a road. In various embodiments, RAN 402 may be the same or similar to RAN 102 and/or RAN 202. As can be seen in FIG. 4, operating environment 400 includes channel agents 410, UE 408, and base stations 406 within RAN 402. In operating environment 400, a radio access KSPCS (not shown) may determine one or more channel state parameters for wireless communication channels between the different devices (e.g., one or more base stations 406 and one or more UEs 408). In various embodiment described herein, the determination of channel state parameters for wireless communication between different devices may improve the performance and efficiency of RAN 402 along a road by limiting the participation of UE 108 in determining channel state parameters (e.g., UE 108 performing channel estimation). Embodiments are not limited in this context.

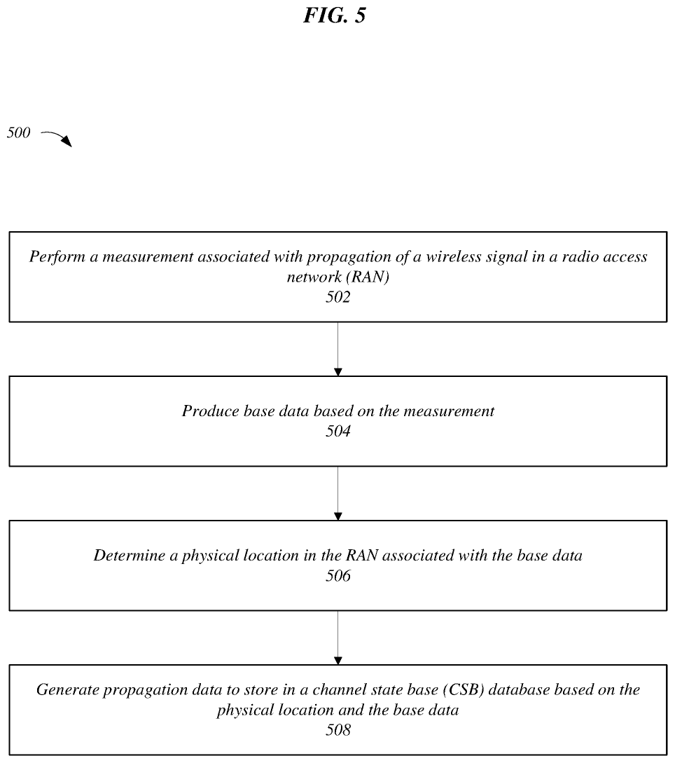

FIG. 5 illustrates one embodiment of a logic flow 500, which may be representative of operations that may be executed in various embodiments in conjunctions with determining channel state parameters. The logic flow 500 may be representative of some or all of the operations that may be executed by one or more components of operating environments 100, 200, 300, 400 of FIGS. 1-4, such as radio access KSPCS 104, 204 or channel agents 110, 210, 310, 410. The embodiments are not limited in this context.

In the illustrated embodiment shown in FIG. 5, the logic flow 500 may begin at block 502. At block 502 “perform a measurement associated with propagation of a wireless signal in a radio access network (RAN)” a measurement associated with propagation of a wireless signal in a RAN may be performed. For example, one or more of channel agents 210 may measure propagating signals and/or conditions affecting propagating signals in RAN 202. In some embodiments, performance of the measurement associated with propagation of a wireless signal in a RAN may be at the direction of radio access KSPCS 104, 204. In some such embodiments, performance of the measurement associated with propagation of a wireless signal in a RAN may be at the direction of channel server 222.

Proceeding to block 504 “produce base data based on the measurement” base data may be produced based on the measurement associated with propagation of a wireless signal in the RAN. For example, one or more of channel agents 110, 210, 310, 410 may produce base data 118, 232 based on measurements associated with propagation of a wireless signal in the respective RAN. In some embodiments, the base data may be stored in CSB database 114, 214.

At block 506 “determine a physical location in the RAN associated with the base data”, a physical location in the RAN associated with the base data may be determined. For example, channel server 222 may determine a physical location associated with the base data by retrieving the associated physical location from localization server 224 based on identification information in the base data (e.g., device identifier). In another example, the base data may include an indication of the associated physical location. In some embodiments, the physical location may include the location of a channel agent or a UE.

Proceeding to block 508 “generate propagation data to store in a channel state base (CSB) database based on the physical location and the base data” propagation data for storage in a CSB data base may be generated based on the physical location and the base data. For example, propagation data 216 may be generated based on base data 232 and location information from localization server 224 for storage in CSB database 214. In some embodiments, channel server 222 may generate the propagation data 216.

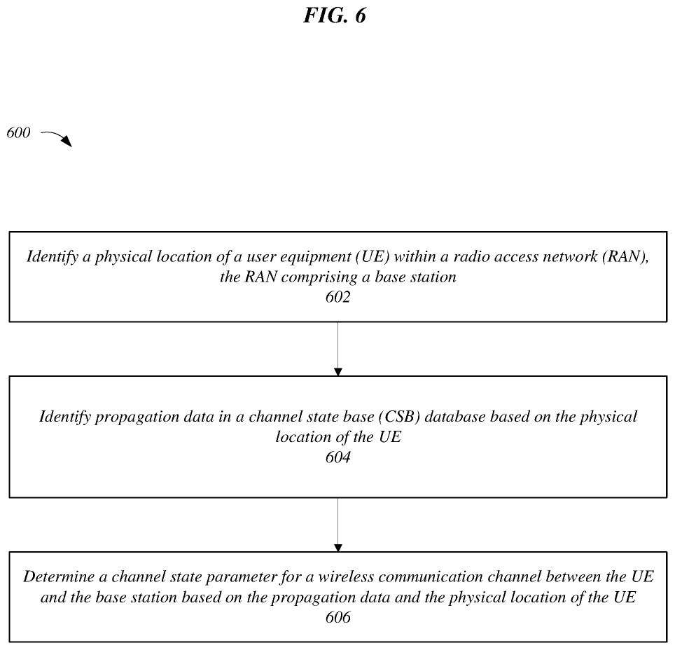

FIG. 6 illustrates one embodiment of a logic flow 600, which may be representative of operations that may be executed in various embodiments in conjunctions with determining channel state parameters. The logic flow 500 may be representative of some or all of the operations that may be executed by one or more components of operating environments 100, 200, 300, 400 of FIGS. 1-4, such as radio access KSPCS 104, 204. The embodiments are not limited in this context.

In the illustrated embodiment shown in FIG. 6, the logic flow 600 may begin at block 602. At block 602 “identify a physical location of a user equipment (UE) within a radio access network (RAN), the RAN comprising a base station” a physical location of a UE within a RAN comprising a base station may be identified. For example, a location of UE 208-1 may be identified by channel server 222 based on a determination by localization server 224. In some embodiments, channel server 222 may identify the physical location by retrieving it from localization server 224.

Proceeding to block 604 “identify propagation data in a channel state base (CSB) database based on the physical location of the UE” propagation data associated with the physical location of the UE may be determined. For example, channel server 222 may identify a portion of propagation data 216 in CSB database 214 associated with the physical location of UE 208-2 within RAN 202. In some embodiments, the propagation data may include a portion of a propagation map of a RAN comprising the physical location.

At block 606 “determine a channel state parameter for a wireless communication channel between the UE and the base station based on the propagation data and the physical location of the UE”, the propagation data and the physical location of the UE may be used to determine a channel state parameter for a wireless communication channel between the UE and the base station. For example, channel server radio access KSPCS may determine one or more channel state parameters for wireless communication channel 112 between base station 106 and UE 108. In some embodiments, channel server 222 may use CSB database 214 and localization server 224 to determine the channel state parameter for the wireless communication channel between a UE and a base station (e.g., UE 208-2 and base station 206-n).

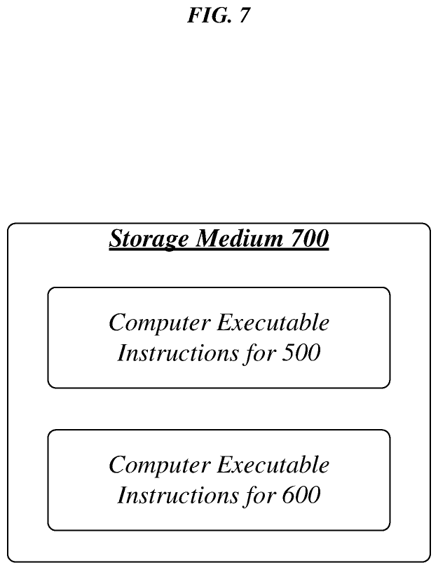

FIG. 7 illustrates an embodiment of a storage medium 700. Storage medium 700 may comprise any computer-readable storage medium or machine-readable storage medium, such as an optical, magnetic or semiconductor storage medium. In some embodiments, storage medium 700 may comprise a non-transitory storage medium. In various embodiments, storage medium 700 may comprise an article of manufacture. In some embodiments, storage medium 700 may store computer-executable instructions, such as computer-executable instructions to implement one or more of logic flow 500 or logic flow 600. Examples of a computer-readable storage medium or machine-readable storage medium may include any tangible media capable of storing electronic data, including volatile memory or non-volatile memory, removable or non-removable memory, erasable or non-erasable memory, writeable or re-writeable memory, and so forth. Examples of computer-executable instructions may include any suitable type of code, such as source code, compiled code, interpreted code, executable code, static code, dynamic code, object-oriented code, visual code, and the like. The embodiments are not limited to these examples.

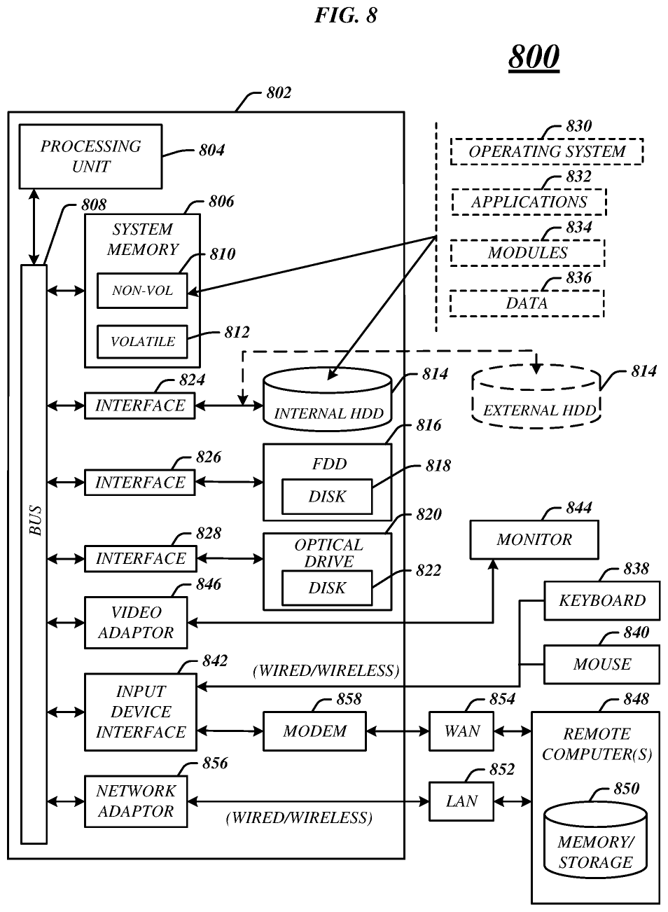

FIG. 8 illustrates an embodiment of an exemplary computing architecture 800 that may be suitable for implementing various embodiments as previously described. In various embodiments, the computing architecture 800 may comprise or be implemented as part of an electronic device. In some embodiments, the computing architecture 800 may be representative, for example, of a computing device suitable for use in conjunction with implementation of one or more components of operating environments 100, 200, 300, 400 or one or more portions of logic flow 500 and/or logic flow 600. The embodiments are not limited in this context.

As used in this application, the terms “system” and “component” and “module” are intended to refer to a computer-related entity, either hardware, a combination of hardware and software, software, or software in execution, examples of which are provided by the exemplary computing architecture 800. For example, a component can be, but is not limited to being, a process running on a processor, a processor, a hard disk drive, multiple storage drives (of optical and/or magnetic storage medium), an object, an executable, a thread of execution, a program, and/or a computer. By way of illustration, both an application running on a server and the server can be a component. One or more components can reside within a process and/or thread of execution, and a component can be localized on one computer and/or distributed between two or more computers. Further, components may be communicatively coupled to each other by various types of communications media to coordinate operations. The coordination may involve the uni-directional or bi-directional exchange of information. For instance, the components may communicate information in the form of signals communicated over the communications media.

The information can be implemented as signals allocated to various signal lines. In such allocations, each message is a signal. Further embodiments, however, may alternatively employ data messages. Such data messages may be sent across various connections. Exemplary connections include parallel interfaces, serial interfaces, and bus interfaces. The computing architecture 800 includes various common computing elements, such as one or more processors, multi-core processors, co-processors, memory units, chipsets, controllers, peripherals, interfaces, oscillators, timing devices, video cards, audio cards, multimedia input/output (I/O) components, power supplies, and so forth. The embodiments, however, are not limited to implementation by the computing architecture 800.

As shown in FIG. 8, according to computing architecture 800, a computer 802 comprises a processing unit 804, a system memory 806 and a system bus 808. In some embodiments, computer 802 may comprise a server. In some embodiments, computer 802 may comprise a client. The processing unit 804 can be any of various commercially available processors, including without limitation an AMD® Athlon®, Duron® and Opteron® processors; ARM® application, embedded and secure processors; IBM® and Motorola® DragonB all® and PowerPC® processors; IBM and Sony® Cell processors; Intel® Celeron®, Core (2) Duo®, Itanium®, Pentium®, Xeon®, and XScale® processors; and similar processors. Dual microprocessors, multi-core processors, and other multi-processor architectures may also be employed as the processing unit 804.

The system bus 808 provides an interface for system components including, but not limited to, the system memory 806 to the processing unit 804. The system bus 808 can be any of several types of bus structure that may further interconnect to a memory bus (with or without a memory controller), a peripheral bus, and a local bus using any of a variety of commercially available bus architectures. Interface adapters may connect to the system bus 808 via a slot architecture. Example slot architectures may include without limitation Accelerated Graphics Port (AGP), Card Bus, (Extended) Industry Standard Architecture ((E)ISA), Micro Channel Architecture (MCA), NuBus, Peripheral Component Interconnect (Extended) (PCI(X)), PCI Express, Personal Computer Memory Card International Association (PCMCIA), and the like.

The system memory 806 may include various types of computer-readable storage media in the form of one or more higher speed memory units, such as read-only memory (ROM), random-access memory (RAM), dynamic RAM (DRAM), Double-Data-Rate DRAM (DDRAM), synchronous DRAM (SDRAM), static RAM (SRAM), programmable ROM (PROM), erasable programmable ROM (EPROM), electrically erasable programmable ROM (EEPROM), flash memory, polymer memory such as ferroelectric polymer memory, ovonic memory, phase change or ferroelectric memory, silicon-oxide-nitride-oxide-silicon (SONOS) memory, magnetic or optical cards, an array of devices such as Redundant Array of Independent Disks (RAID) drives, solid state memory devices (e.g., universal serial bus (USB) memory, solid state drives (SSD) and any other type of storage media suitable for storing information. In the illustrated embodiment shown in FIG. 8, the system memory 806 can include non-volatile memory 810 and/or volatile memory 812. A basic input/output system (BIOS) can be stored in the non-volatile memory 810.

The computer 802 may include various types of computer-readable storage media in the form of one or more lower speed memory units, including an internal (or external) hard disk drive (HDD) 814, a magnetic floppy disk drive (FDD) 816 to read from or write to a removable magnetic disk 818, and an optical disk drive 820 to read from or write to a removable optical disk 822 (e.g., a CD-ROM or DVD). The HDD 814, FDD 816 and optical disk drive 820 can be connected to the system bus 808 by a HDD interface 824, an FDD interface 826 and an optical drive interface 828, respectively. The HDD interface 824 for external drive implementations can include at least one or both of Universal Serial Bus (USB) and IEEE 1394 interface technologies. The drives and associated computer-readable media provide volatile and/or nonvolatile storage of data, data structures, computer-executable instructions, and so forth. For example, a number of program modules can be stored in the drives and memory units 810, 812, including an operating system 830, one or more application programs 832, other program modules 834, and program data 836.

A user can enter commands and information into the computer 802 through one or more wire/wireless input devices, for example, a keyboard 838 and a pointing device, such as a mouse 840. Other input devices may include microphones, infra-red (IR) remote controls, radio-frequency (RF) remote controls, game pads, stylus pens, card readers, dongles, finger print readers, gloves, graphics tablets, joysticks, keyboards, retina readers, touch screens (e.g., capacitive, resistive, etc.), trackballs, trackpads, sensors, styluses, and the like. These and other input devices are often connected to the processing unit 804 through an input device interface 842 that is coupled to the system bus 808, but can be connected by other interfaces such as a parallel port, IEEE 1394 serial port, a game port, a USB port, an IR interface, and so forth.

A monitor 844 or other type of display device is also connected to the system bus 808 via an interface, such as a video adaptor 846. The monitor 844 may be internal or external to the computer 802. In addition to the monitor 844, a computer typically includes other peripheral output devices, such as speakers, printers, and so forth.

The computer 802 may operate in a networked environment using logical connections via wire and/or wireless communications to one or more remote computers, such as a remote computer 848. The remote computer 848 can be a workstation, a server computer, a router, a personal computer, portable computer, microprocessor-based entertainment appliance, a peer device or other common network node, and typically includes many or all of the elements described relative to the computer 802, although, for purposes of brevity, only a memory/storage device 850 is illustrated. The logical connections depicted include wire/wireless connectivity to a local area network (LAN) 852 and/or larger networks, for example, a wide area network (WAN) 854. Such LAN and WAN networking environments are commonplace in offices and companies, and facilitate enterprise-wide computer networks, such as intranets, all of which may connect to a global communications network, for example, the Internet.

When used in a LAN networking environment, the computer 802 is connected to the LAN 852 through a wire and/or wireless communication network interface or adaptor 856. The adaptor 856 can facilitate wire and/or wireless communications to the LAN 852, which may also include a wireless access point disposed thereon for communicating with the wireless functionality of the adaptor 856.

When used in a WAN networking environment, the computer 802 can include a modem 858, or is connected to a communications server on the WAN 854, or has other means for establishing communications over the WAN 854, such as by way of the Internet. The modem 858, which can be internal or external and a wire and/or wireless device, connects to the system bus 808 via the input device interface 842. In a networked environment, program modules depicted relative to the computer 802, or portions thereof, can be stored in the remote memory/storage device 850. It will be appreciated that the network connections shown are exemplary and other means of establishing a communications link between the computers can be used.

The computer 802 is operable to communicate with wire and wireless devices or entities using the IEEE 802 family of standards, such as wireless devices operatively disposed in wireless communication (e.g., IEEE 802.16 over-the-air modulation techniques). This includes at least Wi-Fi (or Wireless Fidelity), WiMax, and Bluetooth™ wireless technologies, among others. Thus, the communication can be a predefined structure as with a conventional network or simply an ad hoc communication between at least two devices. Wi-Fi networks use radio technologies called IEEE 802.11x (a, b, g, n, etc.) to provide secure, reliable, fast wireless connectivity. A Wi-Fi network can be used to connect computers to each other, to the Internet, and to wire networks (which use IEEE 802.3-related media and functions).

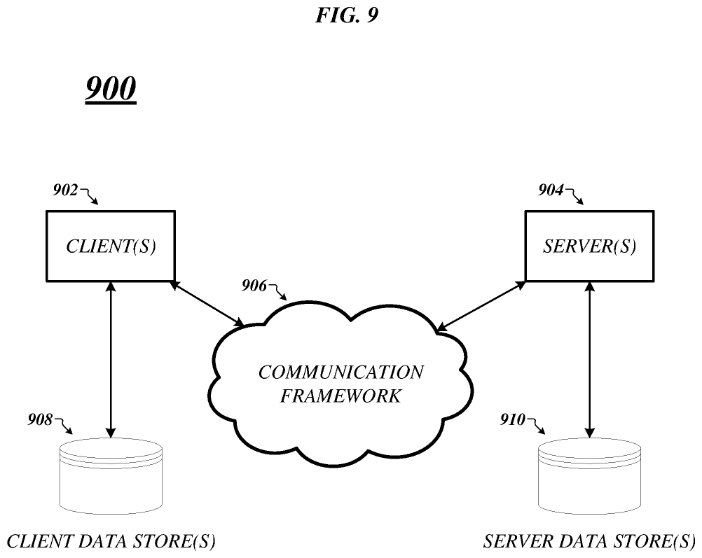

FIG. 9 illustrates a block diagram of an exemplary communications architecture 900 suitable for implementing various embodiments as previously described. The communications architecture 900 includes various common communications elements, such as a transmitter, receiver, transceiver, radio, network interface, baseband processor, antenna, amplifiers, filters, power supplies, and so forth. The embodiments, however, are not limited to implementation by the communications architecture 900.

As shown in FIG. 9, the communications architecture 900 comprises includes one or more clients 902 and servers 904. The clients 902 and the servers 904 are operatively connected to one or more respective client data stores 908 and server data stores 910 that can be employed to store information local to the respective clients 902 and servers 904, such as cookies and/or associated contextual information. Any one of clients 902 and/or servers 904 may implement one or more of base stations 106, 206, 306, 406, UE 108, 208, 308, 408, channel agents 110, 210, 310, 410, one or more components of radio access KSPCS 104, 204, logic flow 500, logic flow 600, and computing architecture 800.

The clients 902 and the servers 904 may communicate information between each other using a communication framework 906. The communications framework 906 may implement any well-known communications techniques and protocols. The communications framework 906 may be implemented as a packet-switched network (e.g., public networks such as the Internet, private networks such as an enterprise intranet, and so forth), a circuit-switched network (e.g., the public switched telephone network), or a combination of a packet-switched network and a circuit-switched network (with suitable gateways and translators).

The communications framework 906 may implement various network interfaces arranged to accept, communicate, and connect to a communications network. A network interface may be regarded as a specialized form of an input output interface. Network interfaces may employ connection protocols including without limitation direct connect, Ethernet (e.g., thick, thin, twisted pair 10/100/1000 Base T, and the like), token ring, wireless network interfaces, cellular network interfaces, IEEE 802.11a-x network interfaces, IEEE 802.16 network interfaces, IEEE 802.20 network interfaces, and the like. Further, multiple network interfaces may be used to engage with various communications network types. For example, multiple network interfaces may be employed to allow for the communication over broadcast, multicast, and unicast networks. Should processing requirements dictate a greater amount speed and capacity, distributed network controller architectures may similarly be employed to pool, load balance, and otherwise increase the communicative bandwidth required by clients 902 and the servers 904. A communications network may be any one and the combination of wired and/or wireless networks including without limitation a direct interconnection, a secured custom connection, a private network (e.g., an enterprise intranet), a public network (e.g., the Internet), a Personal Area Network (PAN), a Local Area Network (LAN), a Metropolitan Area Network (MAN), an Operating Missions as Nodes on the Internet (OMNI), a Wide Area Network (WAN), a wireless network, a cellular network, and other communications networks.

As used herein, the term “circuitry” may refer to, be part of, or include an Application Specific Integrated Circuit (ASIC), an electronic circuit, a processor (shared, dedicated, or group), and/or memory (shared, dedicated, or group) that execute one or more software or firmware programs, a combinational logic circuit, and/or other suitable hardware components that provide the described functionality. In some embodiments, the circuitry may be implemented in, or functions associated with the circuitry may be implemented by, one or more software or firmware modules. In some embodiments, circuitry may include logic, at least partially operable in hardware. Embodiments described herein may be implemented into a system using any suitably configured hardware and/or software.

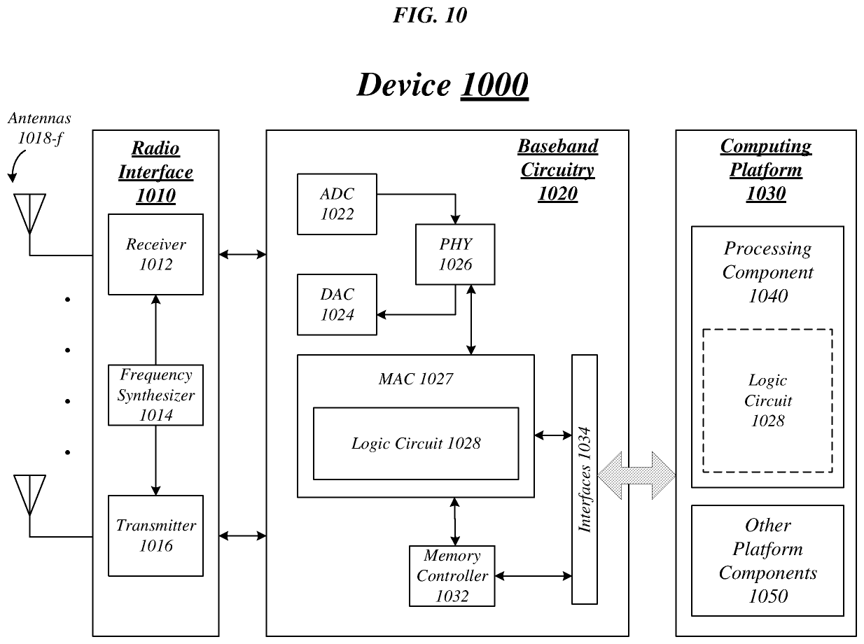

FIG. 10 illustrates an embodiment of a communications device 1000 that may implement one or more of base stations 106, 206, 306, 406, UE 108, 208, 308, 408, channel agents 110, 210, 310, 410, one or more components of radio access KSPCS 104, 204, logic flow 500, logic flow 600, and computing architecture 800 according to some embodiments. In various embodiments, device 1000 may comprise a logic circuit 1028. The logic circuit 1028 may include physical circuits to perform operations described for one or more of base stations 106, 206, 306, 406, UE 108, 208, 308, 408, channel agents 110, 210, 310, 410, one or more components of radio access KSPCS 104, 204, logic flow 500, and logic flow 600, for example. As shown in FIG. 10, device 1000 may include a radio interface 1010, baseband circuitry 1020, and computing platform 1030, although the embodiments are not limited to this configuration.

The device 1000 may implement some or all of the structure and/or operations for one or more of base stations 106, 206, 306, 406, UE 108, 208, 308, 408, channel agents 110, 210, 310, 410, one or more components of radio access KSPCS 104, 204, logic flow 500, logic flow 600, storage medium 700, computing architecture 800, and logic circuit 1028 in a single computing entity, such as entirely within a single device. Alternatively, the device 1000 may distribute portions of the structure and/or operations for one or more of base stations 106, 206, 306, 406, UE 108, 208, 308, 408, channel agents 110, 210, 310, 410, one or more components of radio access KSPCS 104, 204, logic flow 500, logic flow 600, storage medium 700, computing architecture 800, and logic circuit 1028 across multiple computing entities using a distributed system architecture, such as a client-server architecture, a 3-tier architecture, an N-tier architecture, a tightly-coupled or clustered architecture, a peer-to-peer architecture, a master-slave architecture, a shared database architecture, and other types of distributed systems. The embodiments are not limited in this context.

In one embodiment, radio interface 1010 may include a component or combination of components adapted for transmitting and/or receiving single-carrier or multi-carrier modulated signals (e.g., including complementary code keying (CCK), orthogonal frequency division multiplexing (OFDM), and/or single-carrier frequency division multiple access (SC-FDMA) symbols) although the embodiments are not limited to any specific over-the-air interface or modulation scheme. Radio interface 1010 may include, for example, a receiver 1012, a frequency synthesizer 1014, and/or a transmitter 1016. Radio interface 1010 may include bias controls, a crystal oscillator and/or one or more antennas 1018-f. In another embodiment, radio interface 1010 may use external voltage-controlled oscillators (VCOs), surface acoustic wave filters, intermediate frequency (IF) filters and/or RF filters, as desired. Due to the variety of potential RF interface designs an expansive description thereof is omitted. Baseband circuitry 1020 may communicate with radio interface 1010 to process receive and/or transmit signals and may include, for example, a mixer for down-converting received RF signals, an analog-to-digital converter 1022 for converting analog signals to digital form, a digital-to-analog converter 1024 for converting digital signals to analog form, and a mixer for up-converting signals for transmission. Further, baseband circuitry 1020 may include a baseband or physical layer (PHY) processing circuit 1026 for PHY link layer processing of respective receive/transmit signals. Baseband circuitry 1020 may include, for example, a medium access control (MAC) processing circuit 1027 for MAC/data link layer processing. Baseband circuitry 1020 may include a memory controller 1032 for communicating with MAC processing circuit 1027 and/or a computing platform 1030, for example, via one or more interfaces 1034.

In some embodiments, PHY processing circuit 1026 may include a frame construction and/or detection module, in combination with additional circuitry such as a buffer memory, to construct and/or deconstruct communication frames. Alternatively, or in addition, MAC processing circuit 1027 may share processing for certain of these functions or perform these processes independent of PHY processing circuit 1026. In some embodiments, MAC and PHY processing may be integrated into a single circuit.

The computing platform 1030 may provide computing functionality for the device 1000. As shown, the computing platform 1030 may include a processing component 1040. In addition to, or alternatively of, the baseband circuitry 1020, the device 1000 may execute processing operations or logic for one or more of base stations 106, 206, 306, 406, UE 108, 208, 308, 408, channel agents 110, 210, 310, 410, one or more components of radio access KSPCS 104, 204, logic flow 500, logic flow 600, storage medium 700, computing architecture 800, and logic circuit 1028 using the processing component 1040. The processing component 1040 (and/or PHY 1026 and/or MAC 1027) may comprise various hardware elements, software elements, or a combination of both. Examples of hardware elements may include devices, logic devices, components, processors, microprocessors, circuits, processor circuits, circuit elements (e.g., transistors, resistors, capacitors, inductors, and so forth), integrated circuits, application specific integrated circuits (ASIC), programmable logic devices (PLD), digital signal processors (DSP), field programmable gate array (FPGA), memory units, logic gates, registers, semiconductor device, chips, microchips, chip sets, and so forth. Examples of software elements may include software components, programs, applications, computer programs, application programs, system programs, software development programs, machine programs, operating system software, middleware, firmware, software modules, routines, subroutines, functions, methods, procedures, software interfaces, application program interfaces (API), instruction sets, computing code, computer code, code segments, computer code segments, words, values, symbols, or any combination thereof. Determining whether an embodiment is implemented using hardware elements and/or software elements may vary in accordance with any number of factors, such as desired computational rate, power levels, heat tolerances, processing cycle budget, input data rates, output data rates, memory resources, data bus speeds and other design or performance constraints, as desired for a given implementation.

The computing platform 1030 may further include other platform components 1050. Other platform components 1050 include common computing elements, such as one or more processors, multi-core processors, co-processors, memory units, chipsets, controllers, peripherals, interfaces, oscillators, timing devices, video cards, audio cards, multimedia input/output (I/O) components (e.g., digital displays), power supplies, and so forth. Examples of memory units may include without limitation various types of computer readable and machine readable storage media in the form of one or more higher speed memory units, such as read-only memory (ROM), random-access memory (RAM), dynamic RAM (DRAM), Double-Data-Rate DRAM (DDRAM), synchronous DRAM (SDRAM), static RAM (SRAM), programmable ROM (PROM), erasable programmable ROM (EPROM), electrically erasable programmable ROM (EEPROM), flash memory, polymer memory such as ferroelectric polymer memory, ovonic memory, phase change or ferroelectric memory, silicon-oxide-nitride-oxide-silicon (SONOS) memory, magnetic or optical cards, an array of devices such as Redundant Array of Independent Disks (RAID) drives, solid state memory devices (e.g., USB memory, solid state drives (SSD) and any other type of storage media suitable for storing information.

Device 1000 may be, for example, an ultra-mobile device, a mobile device, a fixed device, a machine-to-machine (M2M) device, a personal digital assistant (PDA), a mobile computing device, a smart phone, a telephone, a digital telephone, a cellular telephone, user equipment, eBook readers, a handset, a one-way pager, a two-way pager, a messaging device, a computer, a personal computer (PC), a desktop computer, a laptop computer, a notebook computer, a netbook computer, a handheld computer, a tablet computer, a server, a server array or server farm, a web server, a network server, an Internet server, a work station, a mini-computer, a main frame computer, a supercomputer, a network appliance, a web appliance, a distributed computing system, multiprocessor systems, processor-based systems, consumer electronics, programmable consumer electronics, game devices, display, television, digital television, set top box, wireless access point, base station, node B, subscriber station, mobile subscriber center, radio network controller, router, hub, gateway, bridge, switch, machine, or combination thereof. Accordingly, functions and/or specific configurations of device 1000 described herein, may be included or omitted in various embodiments of device 1000, as suitably desired.

Embodiments of device 1000 may be implemented using single input single output (SISO) architectures. However, certain implementations may include multiple antennas (e.g., antennas 1018-f) for transmission and/or reception using adaptive antenna techniques for beamforming or spatial division multiple access (SDMA) and/or using MIMO communication techniques.

The components and features of device 1000 may be implemented using any combination of discrete circuitry, application specific integrated circuits (ASICs), logic gates and/or single chip architectures. Further, the features of device 1000 may be implemented using microcontrollers, programmable logic arrays and/or microprocessors or any combination of the foregoing where suitably appropriate. It is noted that hardware, firmware and/or software elements may be collectively or individually referred to herein as “logic” or “circuit.”

It should be appreciated that the exemplary device 1000 shown in the block diagram of FIG. 10 may represent one functionally descriptive example of many potential implementations. Accordingly, division, omission or inclusion of block functions depicted in the accompanying figures does not infer that the hardware components, circuits, software and/or elements for implementing these functions would be necessarily be divided, omitted, or included in embodiments.

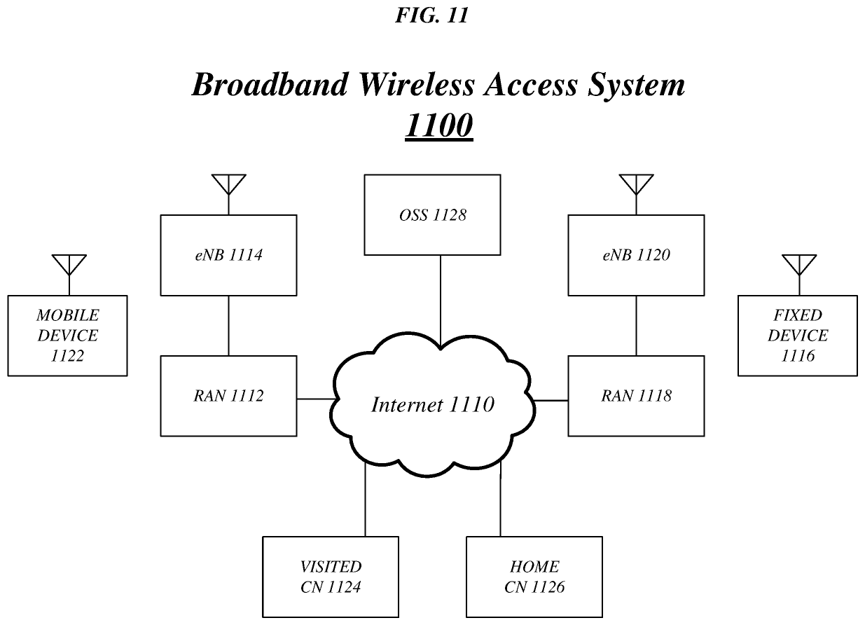

FIG. 11 illustrates an embodiment of a broadband wireless access system 1100. As shown in FIG. 11, broadband wireless access system 1100 may be an internet protocol (IP) type network comprising an internet 1110 type network or the like that is capable of supporting mobile wireless access and/or fixed wireless access to internet 1110. In one or more embodiments, broadband wireless access system 1100 may comprise any type of orthogonal frequency division multiple access (OFDMA)-based or single-carrier frequency division multiple access (SC-FDMA)-based wireless network, such as a system compliant with one or more of the 3GPP LTE Specifications and/or IEEE 802.16 Standards, and the scope of the claimed subject matter is not limited in these respects.

In the exemplary broadband wireless access system 1100, radio access networks (RANs) 1112 and 1118 are capable of coupling with evolved node Bs (eNBs) 1114 and 1120, respectively, to provide wireless communication between one or more fixed devices 1116 and internet 1110 and/or between or one or more mobile devices 1122 and Internet 1110. One example of a fixed device 1116 and a mobile device 1122 is device 1000 of FIG. 10, with the fixed device 1116 comprising a stationary version of device 1000 and the mobile device 1122 comprising a mobile version of device 1000. RANs 1112 and 1118 may implement profiles that are capable of defining the mapping of network functions to one or more physical entities on broadband wireless access system 1100. eNBs 1114 and 1120 may comprise radio equipment to provide RF communication with fixed device 1116 and/or mobile device 1122, such as described with reference to device 1000, and may comprise, for example, the PHY and MAC layer equipment in compliance with a 3GPP LTE Specification or an IEEE 802.16 Standard. eNBs 1114 and 1120 may further comprise an IP backplane to couple to Internet 1110 via RANs 1112 and 1118, respectively, although the scope of the claimed subject matter is not limited in these respects.

Broadband wireless access system 1100 may further comprise a visited core network (CN) 1124 and/or a home CN 1126, each of which may be capable of providing one or more network functions including but not limited to proxy and/or relay type functions, for example authentication, authorization and accounting (AAA) functions, dynamic host configuration protocol (DHCP) functions, or domain name service controls or the like, domain gateways such as public switched telephone network (PSTN) gateways or voice over internet protocol (VoIP) gateways, and/or internet protocol (IP) type server functions, or the like. However, these are merely example of the types of functions that are capable of being provided by visited CN 1124 and/or home CN 1126, and the scope of the claimed subject matter is not limited in these respects. Visited CN 1124 may be referred to as a visited CN in the case where visited CN 1124 is not part of the regular service provider of fixed device 1116 or mobile device 1122, for example where fixed device 1116 or mobile device 1122 is roaming away from its respective home CN 1126, or where broadband wireless access system 1100 is part of the regular service provider of fixed device 1116 or mobile device 1122 but where broadband wireless access system 1100 may be in another location or state that is not the main or home location of fixed device 1116 or mobile device 1122. The embodiments are not limited in this context.

Fixed device 1116 may be located anywhere within range of one or both of eNBs 1114 and 1120, such as in or near a home or business to provide home or business customer broadband access to Internet 1110 via eNBs 1114 and 1120 and RANs 1112 and 1118, respectively, and home CN 1126. It is worthy of note that although fixed device 1116 is generally disposed in a stationary location, it may be moved to different locations as needed. Mobile device 1122 may be utilized at one or more locations if mobile device 1122 is within range of one or both of eNBs 1114 and 1120, for example. In accordance with one or more embodiments, operation support system (OSS) 1128 may be part of broadband wireless access system 1100 to provide management functions for broadband wireless access system 1100 and to provide interfaces between functional entities of broadband wireless access system 1100. Broadband wireless access system 1100 of FIG. 11 is merely one type of wireless network showing a certain number of the components of broadband wireless access system 1100, and the scope of the claimed subject matter is not limited in these respects.

Various embodiments may be implemented using hardware elements, software elements, or a combination of both. Examples of hardware elements may include processors, microprocessors, circuits, circuit elements (e.g., transistors, resistors, capacitors, inductors, and so forth), integrated circuits, application specific integrated circuits (ASIC), programmable logic devices (PLD), digital signal processors (DSP), field programmable gate array (FPGA), logic gates, registers, semiconductor device, chips, microchips, chip sets, and so forth. Examples of software may include software components, programs, applications, computer programs, application programs, system programs, machine programs, operating system software, middleware, firmware, software modules, routines, subroutines, functions, methods, procedures, software interfaces, application program interfaces (API), instruction sets, computing code, computer code, code segments, computer code segments, words, values, symbols, or any combination thereof. Determining whether an embodiment is implemented using hardware elements and/or software elements may vary in accordance with any number of factors, such as desired computational rate, power levels, heat tolerances, processing cycle budget, input data rates, output data rates, memory resources, data bus speeds and other design or performance constraints.

One or more aspects of at least one embodiment may be implemented by representative instructions stored on a machine-readable medium which represents various logic within the processor, which when read by a machine causes the machine to fabricate logic to perform the techniques described herein. Such representations, known as “IP cores” may be stored on a tangible, machine readable medium and supplied to various customers or manufacturing facilities to load into the fabrication machines that actually make the logic or processor. Some embodiments may be implemented, for example, using a machine-readable medium or article which may store an instruction or a set of instructions that, if executed by a machine, may cause the machine to perform a method and/or operations in accordance with the embodiments. Such a machine may include, for example, any suitable processing platform, computing platform, computing device, processing device, computing system, processing system, computer, processor, or the like, and may be implemented using any suitable combination of hardware and/or software. The machine-readable medium or article may include, for example, any suitable type of memory unit, memory device, memory article, memory medium, storage device, storage article, storage medium and/or storage unit, for example, memory, removable or non-removable media, erasable or non-erasable media, writeable or re-writeable media, digital or analog media, hard disk, floppy disk, Compact Disk Read Only Memory (CD-ROM), Compact Disk Recordable (CD-R), Compact Disk Rewriteable (CD-RW), optical disk, magnetic media, magneto-optical media, removable memory cards or disks, various types of Digital Versatile Disk (DVD), a tape, a cassette, or the like. The instructions may include any suitable type of code, such as source code, compiled code, interpreted code, executable code, static code, dynamic code, encrypted code, and the like, implemented using any suitable high-level, low-level, object-oriented, visual, compiled and/or interpreted programming language.

The following examples pertain to further embodiments, from which numerous permutations and configurations will be apparent.

Example 1 is an apparatus for channel state determination, comprising: a memory; and logic, at least a portion of the logic in circuitry coupled to the memory, the logic to: identify a physical location of a user equipment (UE) in a radio access network (RAN), the RAN comprising a base station; identify propagation data in a channel state base (CSB) database based on the physical location of the UE; and determine a channel state parameter for a wireless communication channel between the UE and the base station based on the propagation data and the physical location of the UE.

Example 2 includes the subject matter of Example 1, the logic to determine a propagation behavior of the wireless communication channel based on the propagation data and the physical location of the UE, the channel state parameter determined based on the propagation behavior.

Example 3 includes the subject matter of Example 1, the logic to cause selection of a pre-processing or a pre-channel filter setting based on the channel state parameter.

Example 4 includes the subject matter of Example 3, the channel state parameter comprising a coefficient associated with the pre-channel filter setting, the coefficient determined by a machine-learning algorithm.

Example 5 includes the subject matter of Example 1, the channel state parameter comprising an indication of one or more of a reception point, a transmission point, antenna elements for reception, antenna elements for transmission, antenna array control for reception, antenna array control for transmission, actuator control for reflection or absorption, a filter setting, or devices for transmission or reception support based on network coding.

Example 6 includes the subject matter of Example 1, the propagation data to indicate a propagation characteristic associated with the physical location of the UE.

Example 7 includes the subject matter of Example 1, the propagation data to include at least a portion of a propagation map, the propagation map to indicate propagation characteristics for a plurality of physical locations in the RAN.

Example 8 includes the subject matter of Example 7, the propagation map comprising a quality of service-transmission characteristics-position grid.

Example 9 includes the subject matter of Example 1, the logic to identify base data received from a channel agent and modify one or more portions of the propagation data based on the base data.

Example 10 includes the subject matter of Example 9, the channel agent comprising the UE.

Example 11 includes the subject matter of Example 9, the channel agent comprising one or more of a sensor, a transmitter, a remote radio head (RRH), or an antenna element.

Example 12 includes the subject matter of Example 9, the base data produced by the channel agent based on a measurement associated with propagation of a wireless signal in the RAN.

Example 13 includes the subject matter of Example 9, the logic to utilize a machine-learning algorithm to modify the one or more portions of the propagation data.

Example 14 includes the subject matter of Example 1, the base station to generate a signal for communication to the UE based on the channel state parameter.

Example 15 includes the subject matter of Example 1, the UE to generate a signal for communication to the base station based on the channel state parameter.

Example 16 includes the subject matter of Example 1, the logic to update a portion of the propagation data based on a ray-tracing calculation.

Example 17 includes the subject matter of Example 1, the logic to identify the physical location of the UE based on data received from a localization server.

Example 18 includes the subject matter of Example 17, the localization server to utilize minimization of drive tests (MDT) to determine the physical location of the UE in the RAN.

Example 19 includes the subject matter of Example 1, the RAN comprising a portion of a mobile network.

Example 20 includes the subject matter of Example 1, the logic to configure a channel agent to sense information related to a topology of the RAN.

Example 21 includes the subject matter of Example 1, the logic to send training information to the UE.

Example 22 includes the subject matter of Example 21, the training information to include a beamforming transmission scheme.

Example 23 includes the subject matter of Example 1, the logic to receive training information from the UE.

Example 24 includes the subject matter of Example 23, the training information to include an orientation of the UE.

Example 25 is a system for channel state determination, the system comprising: a radio access network (RAN) comprising a channel agent, the channel agent to perform a measurement associated with propagation of a wireless signal in the RAN and produce base data based on the measurement; and a channel server to identify the base data in a communication, determine a physical location in the RAN associated with the base data, and generate propagation data to store in a channel state base (CSB) database based on the physical location and the base data.

Example 26 includes the subject matter of Example 25, the channel server to direct the channel agent to perform the measurement associated with propagation of the wireless signal in the RAN.

Example 27 includes the subject matter of Example 26, the physical location in the RAN comprising a physical location of the channel agent.

Example 28 includes the subject matter of Example 26, the channel server to direct a second channel agent to transmit the wireless signal that the measurement is associated with.

Example 29 includes the subject matter of Example 28, the physical location in the RAN comprising a physical location of the second channel agent.

Example 30 includes the subject matter of Example 28, the physical location in the RAN to include a receiver physical location and a transmitter physical location, the receiver physical location comprising a physical location of the channel agent and the transmitter physical location comprising a physical location of the second channel agent.

Example 31 includes the subject matter of Example 25, the channel server to identify a climate condition or an obstacle in the RAN based on the base data.

Example 32 includes the subject matter of Example 25, the channel agent comprising one or more of a sensor, a transmitter, a remote radio head (RRH), or an antenna element.

Example 33 includes the subject matter of Example 25, the RAN comprising a portion of a mobile network.

Example 34 includes the subject matter of Example 25, the channel server to generate the propagation data based on a ray-tracing calculation.

Example 35 includes the subject matter of Example 25, the channel server to utilize a machine-learning algorithm to generate the propagation data.

Example 36 includes the subject matter of Example 25, the propagation data to indicate a propagation characteristic associated with the physical location in the RAN.

Example 37 includes the subject matter of Example 25, the propagation data to include at least a portion of a propagation map, the propagation map to indicate propagation characteristics for a plurality of physical locations in the RAN.

Example 38 includes the subject matter of Example 25, the channel server to determine the physical location in the RAN based on the base data.

Example 39 includes the subject matter of Example 25, the communication via a communication link independent of the RAN.

Example 40 includes the subject matter of Example 25, the communication via a communication link in the RAN.

Example 41 includes the subject matter of Example 25, comprising a user equipment (UE) and a base station in the RAN, the channel server to determine a channel state parameter for a wireless communication channel between the UE and the base station based on the propagation data.

Example 42 includes the subject matter of Example 41, the channel server to: identify a physical location of the UE in the RAN; identify propagation data in the CSB database based on the physical location of the UE; and determine the channel state parameter for the wireless communication channel between the UE and the base station based on the propagation data and the physical location of the UE.

Example 43 includes the subject matter of Example 42, the channel server to determine a propagation behavior for the wireless communication channel based on the propagation data and the physical location of the UE, the channel state parameter determined based on the propagation behavior.

Example 44 includes the subject matter of Example 43, the channel server to cause alteration of a pre-channel filter setting based on the channel state parameter.

Example 45 includes the subject matter of Example 44, the channel state parameter comprising a coefficient associated with the pre-channel filter setting, the coefficient determined by a machine-learning algorithm.

Example 46 includes the subject matter of Example 25, comprising a localization server to determine a physical location of a user equipment (UE) in the RAN.

Example 47 includes the subject matter of Example 46, the localization server to utilize minimization of drive tests (MDT) to determine the physical location of the UE in the RAN.

Example 48 includes the subject matter of Example 25, the channel server to request a user equipment (UE) act as the channel agent.

Example 49 includes the subject matter of Example 25, the CSB database to store the propagation data and at least a portion of the base data.

Example 50 includes the subject matter of Example 25, the channel server to process data received from the channel agent to create or update a topology of the RAN.

Example 51 includes the subject matter of Example 25, the channel server to receive data regarding quality of service (QoS) or position information from a user equipment (UE).

Example 52 includes the subject matter of Example 25, the channel server to create a low rate channel to receive a request from an uplink grant.

Example 53 includes the subject matter of Example 25, the channel server to create a channel to receive data from a user equipment (UE) based on at least a portion of the propagation data.

Example 54 is a computer-implemented method, comprising: identifying a physical location of a user equipment (UE) in a radio access network (RAN), the RAN comprising a base station; identifying propagation data in a channel state base (CSB) database based on the physical location of the UE; and determining a channel state parameter for a wireless communication channel between the UE and the base station based on the propagation data and the physical location of the UE.

Example 55 includes the subject matter of Example 54, comprising determining a propagation behavior of the wireless communication channel based on the propagation data and the physical location of the UE, the channel state parameter determined based on the propagation behavior.

Example 56 includes the subject matter of Example 54, comprising selecting a pre-processing or a pre-channel filter setting based on the channel state parameter.

Example 57 includes the subject matter of Example 56, the channel state parameter comprising a coefficient associated with the pre-channel filter setting, the coefficient determined by a machine-learning algorithm.

Example 58 includes the subject matter of Example 54, the channel state parameter comprising an indication of one or more of a reception point, a transmission point, antenna elements for reception, antenna elements for transmission, antenna array control for reception, antenna array control for transmission, actuator control for reflection or absorption, a filter setting, or devices for transmission or reception support based on network coding.

Example 59 includes the subject matter of Example 54, the propagation data indicating a propagation characteristic associated with the physical location of the UE.

Example 60 includes the subject matter of Example 54, the propagation data including at least a portion of a propagation map, the propagation map to indicate propagation characteristics for a plurality of physical locations in the RAN.

Example 61 includes the subject matter of Example 60, the propagation map comprising a quality of service-transmission characteristics-position grid.

Example 62 includes the subject matter of Example 54, comprising identifying base data received from a channel agent and modifying one or more portions of the propagation data based on the base data.

Example 63 includes the subject matter of Example 62, the channel agent comprising the UE.

Example 64 includes the subject matter of Example 62, the channel agent comprising one or more of a sensor, a transmitter, a remote radio head (RRH), or an antenna element.

Example 65 includes the subject matter of Example 62, the base data produced by the channel agent based on a measurement associated with propagation of a wireless signal in the RAN.

Example 66 includes the subject matter of Example 62, comprising utilizing a machine-learning algorithm to modify the one or more portions of the propagation data.

Example 67 includes the subject matter of Example 54, comprising the base station generating a signal for communication to the UE based on the channel state parameter.

Example 68 includes the subject matter of Example 54, comprising the UE generating a signal for communication to the base station based on the channel state parameter.

Example 69 includes the subject matter of Example 54, comprising updating a portion of the propagation data based on a ray-tracing calculation.

Example 70 includes the subject matter of Example 54, comprising identifying the physical location of the UE based on data received from a localization server.

Example 71 includes the subject matter of Example 70, comprising the localization server utilizing minimization of drive tests (MDT) to determine the physical location of the UE in the RAN.

Example 72 includes the subject matter of Example 54, the RAN comprising a portion of a mobile network.

Example 73 includes the subject matter of Example 54, comprising configuring a channel agent to sense information related to a topology of the RAN.

Example 74 includes the subject matter of Example 54, comprising sending training information to the UE.

Example 75 includes the subject matter of Example 74, the training information including a beamforming transmission scheme.

Example 76 includes the subject matter of Example 54, comprising receiving training information from the UE.

Example 77 includes the subject matter of Example 76, the training information including an orientation of the UE.

Example 78 is at least one non-transitory computer-readable medium comprising a set of instructions that, in response to being executed by a processor circuit, cause the processor circuit to: identify a physical location of a user equipment (UE) in a radio access network (RAN), the RAN comprising a base station; identify propagation data in a channel state base (CSB) database based on the physical location of the UE; and determine a channel state parameter for a wireless communication channel between the UE and the base station based on the propagation data and the physical location of the UE.

Example 79 includes the subject matter of Example 78, comprising instructions that, in response to being executed by the processor circuit, cause the processor circuit to determine a propagation behavior of the wireless communication channel based on the propagation data and the physical location of the UE, the channel state parameter determined based on the propagation behavior.

Example 80 includes the subject matter of Example 78, comprising instructions that, in response to being executed by the processor circuit, cause the processor circuit to cause selection of a pre-processing or a pre-channel filter setting based on the channel state parameter.

Example 81 includes the subject matter of Example 80, the channel state parameter comprising a coefficient associated with the pre-channel filter setting, the coefficient determined by a machine-learning algorithm.

Example 82 includes the subject matter of Example 78, the channel state parameter comprising an indication of one or more of a reception point, a transmission point, antenna elements for reception, antenna elements for transmission, antenna array control for reception, antenna array control for transmission, actuator control for reflection or absorption, a filter setting, or devices for transmission or reception support based on network coding.

Example 83 includes the subject matter of Example 78, the propagation data to indicate a propagation characteristic associated with the physical location of the UE.

Example 84 includes the subject matter of Example 78, the propagation data to include at least a portion of a propagation map, the propagation map to indicate propagation characteristics for a plurality of physical locations in the RAN.

Example 85 includes the subject matter of Example 84, the propagation map comprising a quality of service-transmission characteristics-position grid.

Example 86 includes the subject matter of Example 78, comprising instructions that, in response to being executed by the processor circuit, cause the processor circuit to identify base data received from a channel agent and modify one or more portions of the propagation data based on the base data.

Example 87 includes the subject matter of Example 86, the channel agent comprising the UE.

Example 88 includes the subject matter of Example 86, the channel agent comprising one or more of a sensor, a transmitter, a remote radio head (RRH), or an antenna element.

Example 89 includes the subject matter of Example 86, the base data produced by the channel agent based on a measurement associated with propagation of a wireless signal in the RAN.

Example 90 includes the subject matter of Example 86, comprising instructions that, in response to being executed by the processor circuit, cause the processor circuit to utilize a machine-learning algorithm to modify the one or more portions of the propagation data.

Example 91 includes the subject matter of Example 78, the base station to generate a signal for communication to the UE based on the channel state parameter.

Example 92 includes the subject matter of Example 78, the UE to generate a signal for communication to the base station based on the channel state parameter.

Example 93 includes the subject matter of Example 78, comprising instructions that, in response to being executed by the processor circuit, cause the processor circuit to update a portion of the propagation data based on a ray-tracing calculation.

Example 94 includes the subject matter of Example 78, comprising instructions that, in response to being executed by the processor circuit, cause the processor circuit to identify the physical location of the UE based on data received from a localization server.

Example 95 includes the subject matter of Example 94, the localization server to utilize minimization of drive tests (MDT) to determine the physical location of the UE in the RAN.

Example 96 includes the subject matter of Example 78, the RAN comprising a portion of a mobile network.

Example 97 includes the subject matter of Example 78, comprising instructions that, in response to being executed by the processor circuit, cause the processor circuit to configure a channel agent to sense information related to a topology of the RAN.

Example 98 includes the subject matter of Example 78, comprising instructions that, in response to being executed by the processor circuit, cause the processor circuit to send training information to the UE.

Example 99 includes the subject matter of Example 98, the training information to include a beamforming transmission scheme.

Example 100 includes the subject matter of Example 78, comprising instructions that, in response to being executed by the processor circuit, cause the processor circuit to receive training information from the UE.

Example 101 includes the subject matter of Example 100, the training information to include an orientation of the UE.

Example 102 is an apparatus for channel state determination, the apparatus comprising: means for identifying a physical location of a user equipment (UE) in a radio access network (RAN), the RAN comprising a base station; means for identifying propagation data in a channel state base (CSB) database based on the physical location of the UE; and means for determining a channel state parameter for a wireless communication channel between the UE and the base station based on the propagation data and the physical location of the UE.

Example 103 includes the subject matter of Example 102, comprising means for determining a propagation behavior of the wireless communication channel based on the propagation data and the physical location of the UE, the channel state parameter determined based on the propagation behavior.

Example 104 includes the subject matter of Example 102, comprising means for selecting a pre-processing or a pre-channel filter setting based on the channel state parameter.

Example 105 includes the subject matter of Example 104, the channel state parameter comprising a coefficient associated with the pre-channel filter setting, the coefficient determined by a machine-learning algorithm.

Example 106 includes the subject matter of Example 102, the channel state parameter comprising an indication of one or more of a reception point, a transmission point, antenna elements for reception, antenna elements for transmission, antenna array control for reception, antenna array control for transmission, actuator control for reflection or absorption, a filter setting, or devices for transmission or reception support based on network coding.

Example 107 includes the subject matter of Example 102, the propagation data indicating a propagation characteristic associated with the physical location of the UE.

Example 108 includes the subject matter of Example 102, the propagation data including at least a portion of a propagation map, the propagation map to indicate propagation characteristics for a plurality of physical locations in the RAN.

Example 109 includes the subject matter of Example 108, the propagation map comprising a quality of service-transmission characteristics-position grid.

Example 110 includes the subject matter of Example 102, comprising means for identifying base data received from a channel agent and modifying one or more portions of the propagation data based on the base data.

Example 111 includes the subject matter of Example 110, the channel agent comprising the UE.

Example 112 includes the subject matter of Example 110, the channel agent comprising one or more of a sensor, a transmitter, a remote radio head (RRH), or an antenna element.

Example 113 includes the subject matter of Example 110, the base data produced by the channel agent based on a measurement associated with propagation of a wireless signal in the RAN.

Example 114 includes the subject matter of Example 110, comprising means for utilizing a machine-learning algorithm to modify the one or more portions of the propagation data.

Example 115 includes the subject matter of Example 102, the base station comprising means for generating a signal for communication to the UE based on the channel state parameter.

Example 116 includes the subject matter of Example 102, the UE comprising means for generating a signal for communication to the base station based on the channel state parameter.

Example 117 includes the subject matter of Example 102, comprising means for updating a portion of the propagation data based on a ray-tracing calculation.

Example 118 includes the subject matter of Example 102, comprising means for identifying the physical location of the UE based on data received from a localization server.

Example 119 includes the subject matter of Example 118, the localization server comprising means for utilizing minimization of drive tests (MDT) to determine the physical location of the UE in the RAN.

Example 120 includes the subject matter of Example 102, the RAN comprising a portion of a mobile network.

Example 121 includes the subject matter of Example 102, comprising means for configuring a channel agent to sense information related to a topology of the RAN.

Example 122 includes the subject matter of Example 102, comprising means for sending training information to the UE.

Example 123 includes the subject matter of Example 122, the training information including a beamforming transmission scheme.

Example 124 includes the subject matter of Example 102, comprising means for receiving training information from the UE.

Example 125 includes the subject matter of Example 124, the training information including an orientation of the UE.

The foregoing description of example embodiments has been presented for the purposes of illustration and description. It is not intended to be exhaustive or to limit the present disclosure to the precise forms disclosed. Many modifications and variations are possible in light of this disclosure. It is intended that the scope of the present disclosure be limited not by this detailed description, but rather by the claims appended hereto. Future filed applications claiming priority to this application may claim the disclosed subject matter in a different manner, and may generally include any set of one or more limitations as variously disclosed or otherwise demonstrated herein.

1.-25. (canceled)

26. An apparatus for channel state determination, comprising:
a memory; and
logic, at least a portion of the logic in circuitry coupled to the memory, the logic to:
identify a physical location of a user equipment (UE) in a radio access network (RAN), the RAN comprising a base station;
identify propagation data in a channel state base (CSB) database based on the physical location of the UE; and
determine a channel state parameter for a wireless communication channel between the UE and the base station based on the propagation data and the physical location of the UE.

27. The apparatus of claim 26, the logic to determine a propagation behavior of the wireless communication channel based on the propagation data and the physical location of the UE, the channel state parameter determined based on the propagation behavior.

28. The apparatus of claim 26, the logic to cause selection of a pre-processing or a pre-channel filter setting based on the channel state parameter.

29. The apparatus of claim 28, the channel state parameter comprising a coefficient associated with the pre-channel filter setting, the coefficient determined by a machine-learning algorithm.

30. The apparatus of claim 26, the channel state parameter comprising an indication of one or more of a reception point, a transmission point, antenna elements for reception, antenna elements for transmission, antenna array control for reception, antenna array control for transmission, actuator control for reflection or absorption, a filter setting, or devices for transmission or reception support based on network coding.

31. The apparatus of claim 26, the propagation data to indicate a propagation characteristic associated with the physical location of the UE.

32. The apparatus of claim 26, the propagation data to include at least a portion of a propagation map, the propagation map to indicate propagation characteristics for a plurality of physical locations in the RAN.

33. The apparatus of claim 32, the propagation map comprising a quality of service-transmission characteristics-position grid.

34. The apparatus of claim 26, the logic to identify base data received from a channel agent and modify one or more portions of the propagation data based on the base data.

35. The apparatus of claim 34, the channel agent comprising the UE.

36. The apparatus of claim 34, the channel agent comprising one or more of a sensor, a transmitter, a remote radio head (RRH), or an antenna element.

37. The apparatus of claim 34, the base data produced by the channel agent based on a measurement associated with propagation of a wireless signal in the RAN.

38. The apparatus of claim 34, the logic to utilize a machine-learning algorithm to modify the one or more portions of the propagation data.

39. A system for channel state determination, the system comprising:
a radio access network (RAN) comprising a channel agent, the channel agent to perform a measurement associated with propagation of a wireless signal in the RAN and produce base data based on the measurement; and
a channel server to identify the base data in a communication, determine a physical location in the RAN associated with the base data, and generate propagation data to store in a channel state base (CSB) database based on the physical location and the base data.

40. The system of claim 39, the channel server to direct the channel agent to perform the measurement associated with propagation of the wireless signal in the RAN.

41. The system of claim 40, the physical location in the RAN comprising a physical location of the channel agent.

42. The system of claim 40, the channel server to direct a second channel agent to transmit the wireless signal that the measurement is associated with.

43. The system of claim 42, the physical location in the RAN comprising a physical location of the second channel agent.

44. A computer-implemented method, comprising:
identifying a physical location of a user equipment (UE) in a radio access network (RAN), the RAN comprising a base station;
identifying propagation data in a channel state base (CSB) database based on the physical location of the UE; and
determining a channel state parameter for a wireless communication channel between the UE and the base station based on the propagation data and the physical location of the UE.

45. The computer-implemented method of claim 44, comprising determining a propagation behavior of the wireless communication channel based on the propagation data and the physical location of the UE, the channel state parameter determined based on the propagation behavior.

46. The computer-implemented method of claim 44, comprising selecting a pre-processing or a pre-channel filter setting based on the channel state parameter.

47. The computer-implemented method of claim 46, the channel state parameter comprising a coefficient associated with the pre-channel filter setting, the coefficient determined by a machine-learning algorithm.

48. At least one non-transitory computer-readable medium comprising a set of instructions that, in response to being executed by a processor circuit, cause the processor circuit to:
identify a physical location of a user equipment (UE) in a radio access network (RAN), the RAN comprising a base station;
identify propagation data in a channel state base (CSB) database based on the physical location of the UE; and
determine a channel state parameter for a wireless communication channel between the UE and the base station based on the propagation data and the physical location of the UE.

49. The at least one non-transitory computer-readable medium of claim 48, comprising instructions that, in response to being executed by the processor circuit, cause the processor circuit to determine a propagation behavior of the wireless communication channel based on the propagation data and the physical location of the UE, the channel state parameter determined based on the propagation behavior.

50. The at least one non-transitory computer-readable medium of claim 48, comprising instructions that, in response to being executed by the processor circuit, cause the processor circuit to cause selection of a pre-processing or a pre-channel filter setting based on the channel state parameter.
